(19) United States
(12) Patent Application Publication
(10) Pub. No.: US 2025/0260505 A1
(43) Pub. Date: Aug. 14, 2025

(54) POSITIONING DETERMINATION AT USER EQUIPMENT UNDER AMPLIFY-AND-FORWARD RELAY JAMMING

(71) Applicant: Government of the United States as represented by the Secretary of the Air Force, Wright-Patterson AFB, OH (US)

(72) Inventors: Hyuck Kwon, Wichita, KS (US); Jyothi Sri Sai Manne, Fort Worth, TX (US); Khanh Pham, Albuquerque, NM (US); Shikhar Bhattarai, Wichita, KS (US); Manjula Naik Banavath, Wichita, KS (US); Walter Roensch, JR., Wichita, KS (US)

(21) Appl. No.: 19/051,825

(22) Filed: Feb. 12, 2025

Related U.S. Application Data
(60) Provisional application No. 63/552,831, filed on Feb. 13, 2024.

(51) Int. Cl. H04K 3/00

(52) U.S. Cl. CPC H04K 3/22; H04K 3/25; H04K 3/90

(57) ABSTRACT

An amplify-and-forward (AF) relay jamming signal can pass through any civil and military wireless communication system. Hence, AF relay jamming is dangerous and should be detected and suppressed before demodulation/decoding/decryption in wireless communication systems. The 5G positioning reference signal (PRS) and 5G sounding reference signal (SRS) play critical roles especially for autonomous driving and link establishment between a user equipment (UE) and a near gNodeB. Both the PRS and SRS are publicly known and vulnerable to AF relay jamming. The goal of this invention is to present an effective and low-complexity 5G-and-beyond UE positioning algorithm installed at a UE instead of a gNodeB against an AF 2-dimensional time delay (TD) and frequency shift (FS) relay jamming. Preliminary results for the proposed algorithm using both a 5G PRS and a Global Positioning System (GPS) receiver scenario are presented under a 2D and 1D AF TD relay jamming environment to validate the effectiveness of the proposed algorithm.

Pursuant to 37 C.F.R. § 1.78(a)(4), this application claims the benefit of and priority to prior filed co-pending Provisional Application Ser. No. 63/552,831, filed Feb. 13, 2024, which is expressly incorporated herein by reference.

### RIGHTS OF THE GOVERNMENT

The invention described herein may be manufactured and used by or for the Government of the United States for all governmental purposes without the payment of any royalty.

### FIELD OF THE DISCLOSURE

This discloser presents aspects which pertain to communication jamming and anti-jamming. Some embodiments relate to the use of machine learning to discriminate between jamming signals and actual communication signals.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Network use continues to increase due to both an increase in the types of devices using network resources as well as the amount of data and bandwidth being used by various applications on individual devices, such as video streaming, operating on these communication devices. The increase in network use may cause physical layer problems within the network, such as increasing the amount of interference within the system, which may decrease the network effectiveness and perhaps limit communications. In addition to inadvertent interference, however, the interference may be deliberate in certain situations. Such deliberate interference may include jamming used in electronic warfare to, for example, eliminate the electronic tracking capabilities of a vehicle or a Denial-of-Service (DOS) attack to, for example, remove the ability of a handheld device or laptop to access the network. Independent of the jamming circumstances, jamming can be implemented in a continuous or discontinuous manner and in a wideband or narrowband manner. In the former, a jammer may continuously transmit high power signals in the desired frequency range irrespective of whether packets are being transmitted; in the latter (reactive jamming), the jammer senses the use of the spectrum and responds by jamming all or portions of the packets being transmitted.

Reactive jamming uses less energy and is relatively difficult to detect (compared to continuous jamming) due to the length of the jamming signal, which may be significantly shorter than the transmission. It would be desirable to enable a system and method able to discriminate between intentional jamming signals and normal interference caused by other communication devices using the same frequency bands, and permit communications despite the presence of the jamming signals.

Direct-sequence spread-spectrum (DSSS) and frequency hopping (FH) have been popular for protecting civil and military communication systems from intentional interference/jamming. However, an amplify-and-forward (AF) relay jamming signal can pass through any civil and military wireless communication system. For example, encrypted/nonencrypted, DSSS/no-spread, and FH/non-FH systems. Hence, AF relay jamming is dangerous and should be detected and suppressed before the demodulation or decoding or decryption in wireless communication systems.

Recently, 5G wireless communication systems have been launched, and 5G-and-beyond systems, e.g., 6G, have been under discussion for next-generation systems. The 5G positioning reference signal (PRS) and 5G sounding reference signal (SRS) play critical roles, especially for autonomous driving and link establishment between user equipment (UE) and a near gNodeB (gNB) node. The 2D time delay (TD) and frequency shift (FS) structure of PRS and SRS are similar to each other, and publicly known. Hence, both are vulnerable to AF relay jamming.

Existing 5G positioning methods, in general, are derived from timing, angular, power-based techniques and their combination. There has been no significant investigation about 5G-and-beyond positioning or synchronization against AF relay jamming, although there has been investigation into global navigation satellite system (GNSS) spoofing. While the AF relay jamming signal may seem analogous to a GNSS spoofing signal, the AF relay jamming can be more involved in a game theory than a GNSS spoofing signal.

### SUMMARY

It is desired to overcome jamming of a network by detected jammer signals and avoiding the jammer to transmit the communication signals. To this end, a wideband autonomous cognitive radio comprising a software-defined radio (SDR) and a cognitive engine (CE) as described herein may be designed to use at least one channel for spectrum sensing to track the jammer while at least another channel is used to perform actual communication in commercial and/or military communication systems and hands. A cognitive radio may be configured to employ dynamic spectrum management by using one or more channels to avoid interference and congestion by sensing the RF environment to detect the signals present and the available channels, making decisions based on the types of signals present and adjusting communications accordingly based on interference patterns. The controller in the cognitive radio, named the cognitive engine, may alter communication parameters such as the frequency, time and/or modulation type to enable communications in communications channel, which may be a white space unoccupied by signals or gray space only partially occupied by signals.

A first step in the dynamic avoidance may be to discriminate between valid signals/interference from other network devices (e.g., cellphones) and from those created by a jammer. The cognitive radio may use a machine-learning trained classifier for such signal identification. The machine-learning trained classifier may be implemented at least in part by an artificial neural network. The machine-learning trained classifier may extract features in real-time from a sub-band signal that may contain multiple signals at unknown frequencies. A multi-stage hierarchical signal classification and identification framework may be used along with a sensing policy in which all signals in the sensing channel may first be detected, and parameters such as the center-frequencies and approximate bandwidths of the signals may subsequently be estimated. After estimation of the signal parameters, a digital down-conversion (DDC) process may be used on each of the signals using digitally-synthesized carriers. Digital low-pass filters (LPF) may then be applied to each of the digital down-converted signals to extract each of the signals in isolation. Finally, the feature vectors of each signal may be extracted and passed on to the classifier.

In some embodiments, the cognitive radio may determine whether the channel on which actual communications are received is being jammed based on one or both error vector magnitude (DIM) or modulation error rate (MER). Both the sensing channel and the communications channel may use reinforcement learning (RL) methods to learn how to track the jammer accurately and how to avoid the jammer effectively. The learning mechanisms may be coupled so that whenever the communications channel is jammed before the sensing policy is able to indicate to the controller to switch from the current communications channel to a different communications channel, both the current sensing and communications policies are penalized. The result of perfect learning is a situation in which the communications channel is always switched to a new channel just before jammer arrives in the current communications channel to jam the current communications channel, thereby depriving the jammer the chance to learn where the communications signal is at any given time. Similarly, under perfect learning, the sensing policy will always exactly follow the jammer (jammer tracking).

Current technologies, even if able to take rudimentary countermeasures, may be susceptible to a smart jammer, which itself may be able to alter behavior based on the radio transmissions. The cognitive anti-jamming system described herein may thus learn in real-time and may be able to accordingly reconfigure its communications mode to rapidly respond to the time-varying channel and jammer dynamics. Unlike other cognitive radios, the sensing and communications policy described below may essentially be a “Plug-n-Play” cognitive engine that avoids replacement of the entire radio. Instead, the cognitive operation is all controlled by signal processing, machine learning and decision-making algorithms implemented in a stand-alone cognitive engine module. This has the ability to interface with third-party, legacy or custom-built SDR platforms to realize a functioning cognitive radio system.

The objective of this invention is to present a location finding method at a UE device instead at a gNodeB base station under an AF relay jamming attack. Specifically, a 5G UE determines an AF relay jamming signal presence, estimates the AF relay jamming signal when an AF jamming signal is present, and removes the estimate of the AF relay jamming signal from the received signal, and determines the UE location at the UE.

The benefit of the invented method is the following: The existing 5G system determines the location of a UE at a center gNB base station for beamforming purpose by using the SRS and other PRS related signals received from the UE with collaboration of the neighbor gNB base stations. When these gNB base stations are not trustful especially in a war environment, the invented method will be beneficial, compared to the existing 5G PRS method because (1) the location of a UE will not be exposed to the untrustful gNB base stations, which is good in the sense of UE location secrecy, (2) processing and sending the UE location estimation to the UE from the center gNB base station will not be necessary, (3) the overall processing time will be shortened due to no feedback from the UE to the gNBs, and (4) SRS signal from the UE to the three gNB base stations is not necessary to be transmitted.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows that 5G UE receives 3 positioning reference signals (PRSs) from 3 gNodeB base stations and an amplify-and-forward relay jamming signal.

FIG. 2 shows 5G PRS pattern for comb size K_{comb}^{PRS}=4.

FIG. 3 shows 5G PRS pattern for comb size K_{comb}^{PRS}=12.

FIG. 4 shows the 5G-and-beyond positioning solution against an AF time delay (TD) and frequency shift (FS) relay jamming.

FIG. 5 shows a slot configuration for two 5G PRS resources.

FIG. 6 shows the received signal under AF relay jamming signal.

FIG. 7 shows the cyclic cross-correlation between the GPS receiver signal and the PN sequence versus the lag.

FIG. 8 shows the received signal after elimination of AF TD jamming signal.

FIG. 9 shows the cyclic cross-correlation between reference PN signal and filtered signal.

FIG. 10 shows the probability of success versus amplitude A, SNR=−10 dB.

FIG. 11 shows the 2D cross correlation before jamming signal removal.

FIG. 12 shows the 2D cross correlation after jamming signal removal.

FIG. 13 shows the simulated probability detection before jamming signal removal.

FIG. 14 shows the simulated probability detection after jamming signal removal.

FIG. 15 shows the theoretical probability detection before AF relay jamming signal removal using Neyman-Pearson method.

FIG. 16 shows the theoretical probability detection after AF relay jamming signal removal using Neyman-Pearson method.

FIG. 17 shows the simulated probability detection before and after AF relay jamming signal removal when SNR=20 dB and bandwidth W=100 MHz.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity of illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

The necessary notations are introduced as follows: τ_{gNB,AF} is the waveform propagation time delay from the gNB to the AF TD FS jammer, τ_{AF,RX} is the waveform propagation time delay from the AF TD FS jammer to the 5G receiver, τ_{AF} is the intentional time delay introduced by the AF TD FS jammer, n_{AF} is the intentional subcarrier shift introduced by the AF TD FS jammer, w_{AF}[n] is the AWGN frequency noise at the AF TD FS relay jamming, and w_{RX}[n] is the additive white Gaussian noise (AWGN) frequency noise at the 5G receiver.

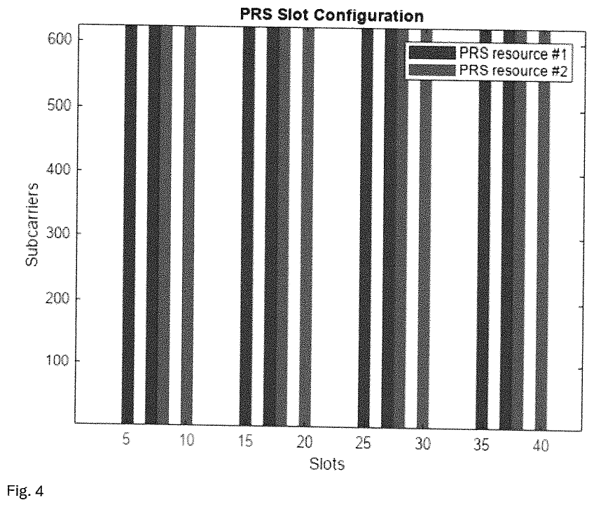

The stacked received vector contributed by the AF TD FS relay jamming signal after the digital Fourier transform (DFT) in FIG. 4 can be written as:

$${r}_{gNB , AF , RX} = {A}_{gNB , AF , RX} {h}_{AF , RX} [ {n}_{AF} ] + ( √ 2 {P}_{A} ) {\tilde{w}}_{AF} + w \qquad ( 1 )$$

Therefore, the overall (N×1) received vector at the 5G PRS receiver contributed by both the gNB and the AF TD FS relay jamming signal after the DFT in FIG. 4 can be written as

$$r = {r}_{gNB} + {r}_{gNB , AF , RX} \qquad ( 2 )$$

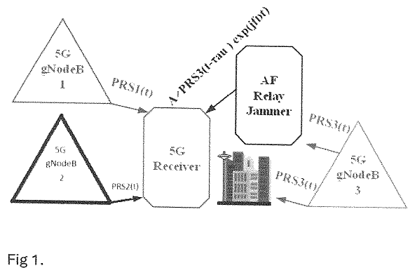

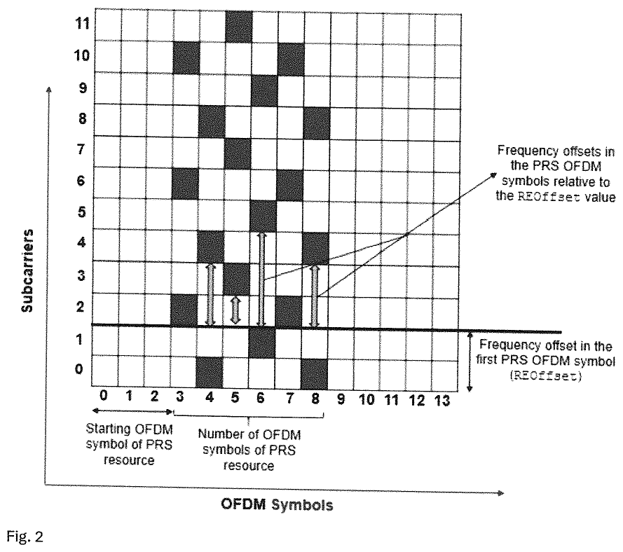

and if three gNBi, i=1, 2, 3, are present under the AF TD FS relay jamming as shown in FIG. 1, then the received vector can be written as

$$r = {\sum }_{i = 1}^{3} {r}_{gNBi} + {r}_{gNB 3 , AF , RX} . \qquad ( 3 )$$

Received vector r in (3) can be fed into the proposed algorithm in Step 1 for cyclic cross-correlation, and the power P_{AF}, time delay τ_{AF}, and subcarrier frequency shift n_{AF} of the AF TD FS relay jamming can be estimated.

The coherent system is assumed for a worst-case analysis under jamming where the phase and time of the receiver are synchronized to those of the AF relay jamming signal. Described herein is the proposed algorithm that can detect and eliminate an amplify-and-forward time delay and frequency shift relay jamming signal x_{AF}(t)=A_{AF}y_{AF}(t−τ_{AF}) in the received signal r(t) for UE positioning, where y_{AF}(t), A_{AF}, and τ_{AF} are, respectively, the received signal, amplifying gain, and time delay at the AF relay jammer.

This disclosure is based on the technique of correlation between the received signal and an available reference signal. Whenever the peak value of the correlation is abnormal, then the invented location signal enhancing process is to detect the amplify-and-forward relay jamming signal, remove, and retake the correlation after the removal of the AF relay jamming signal. This way will improve performance aspects of resilience, continuity, and availability for incumbent positioning, navigation, and timing (PNT) services significantly.

The described six steps will be employed for how to use the invention. Protected positioning, navigation, and timing of a 5G-enabled user equipment can be improved significantly under an AF relay jamming signal attack, compared to the existing anti-jamming or snooping techniques.
The first step is to take a 2D cyclic-cross correlation between the discrete-time received signal vector r=(r[0], . . . , r[N−1])^{T} (which is taken at the UE receiver after discrete-time Fourier transform (DFT) or fast Fourier transform (FFT)) and the known 5G PRS vector b=(b[0], . . . , b[N−1])^{T}, which is assigned in both the orthogonal frequency division multiplexing (OFDM) subcarrier frequency and the OFDM symbol time domain. Here, N can represent the number of subcarriers per OFDM symbol (or can be extended to the total number of subcarriers in the assigned 2D resource blocks [RBs] for a PRS).
Step 2. Detect the presence of an AF TD and FS relay jamming signal by observing whether or not the 2D cyclic-cross correlation peak value is larger than a normal operation threshold which should be designed in prior.
Step 3. Estimate the AF TD and FS relay jamming signal using the peak value and the peak position lag, and filter out any AF relay jamming signal that is detected.
Step 4. Retake the 2D cyclic-cross correlation between the known PRS vector b and the received signal vector \hat{ }r=(r\hat{ }[0], . . . , r\hat{ }[N−1])\hat{ }T after the AF relay jamming signal is eliminated.
Step 5. Repeat Steps 1 to 4 for the other two gNB PRSs (or three more when the UE clock offset is unknown).
Step 6. Apply a trilateral algorithm, and estimate the UE position using all three estimated waveform propagation time delays between the UE and the three (or four) gNBs.
D The proposed algorithm was tested under an AWGN channel and found to be effective for the existing Global Positioning System (GPS) positioning, which is a 1-dimensional (1D) propagation time delay t search against AF relay jamming.

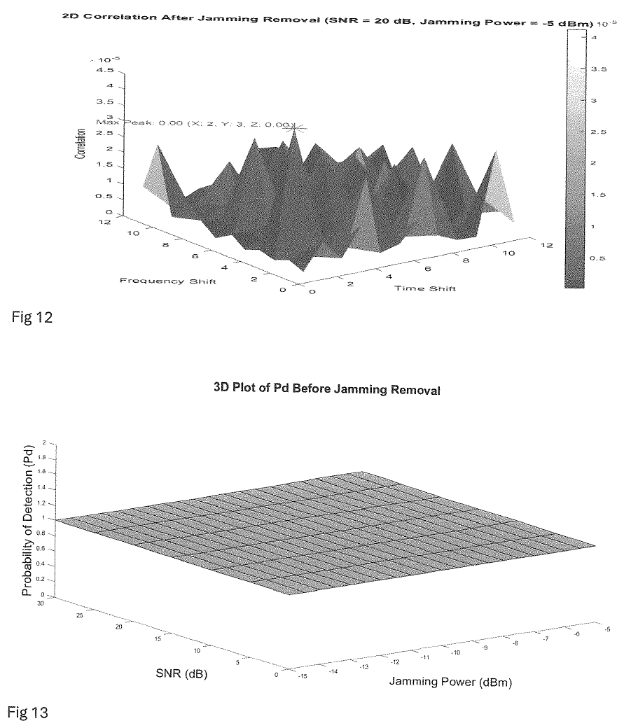

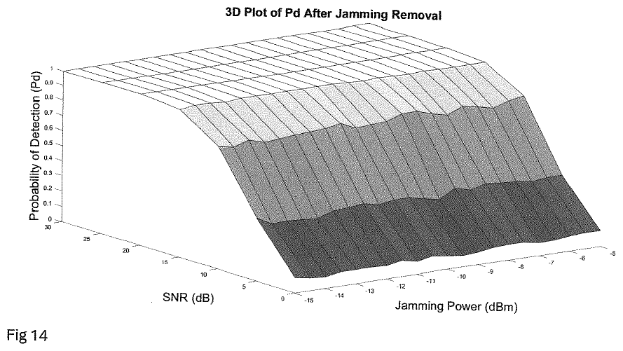

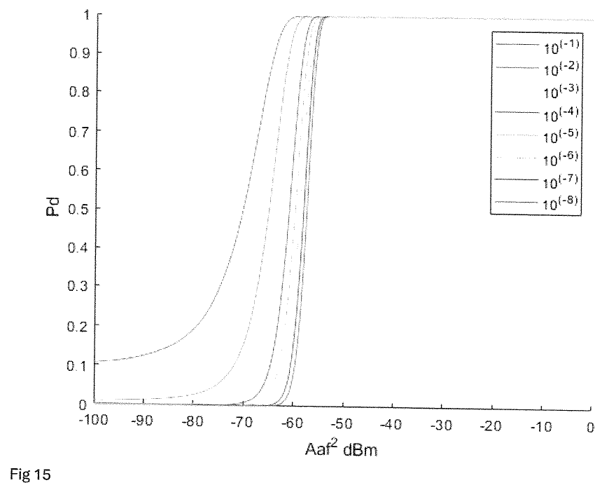

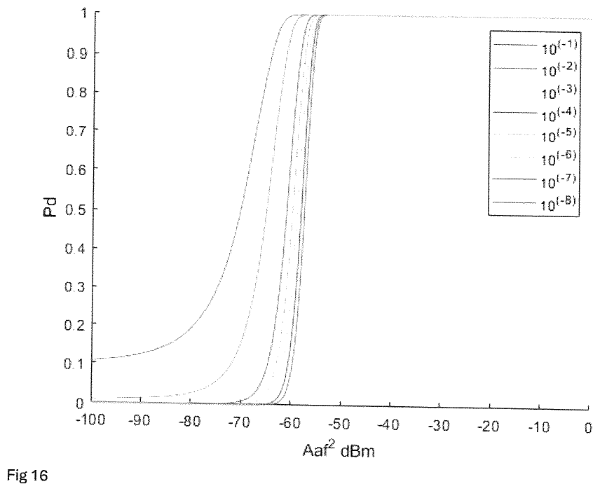

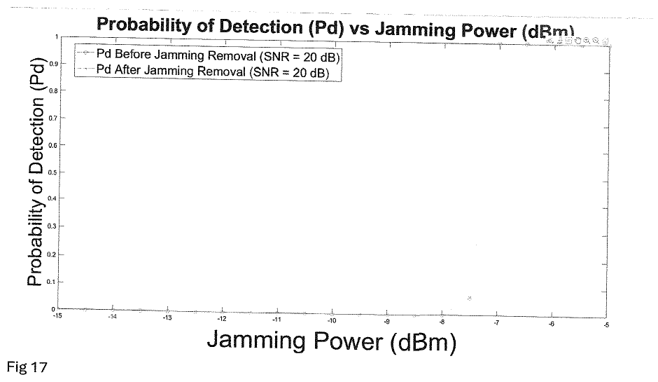

The algorithm was also extended for the 2D 5G PRS signal and tested under an AWGN channel and an AF relay jamming, and found to be effective. For example, the invented 2D 5G PRS algorithm was applied with an existing 2D 5G PRS pattern of comb size=12 in FIG. 4. The results are shown in FIGS. 11, 12, 13, 14, 15, 16, and 17 which show superior performance of the proposed 2D PRS algorithm over the existing 5G PRS method which does not remove the AF jamming signal. The 5G PRS is publicly known and vulnerable to AF relay jamming. Better PRS performance results were observed with the proposed 2D algorithm for 5G-and-beyond positioning than the existing 5G PRS method, which does not remove the AF relay jamming signals.

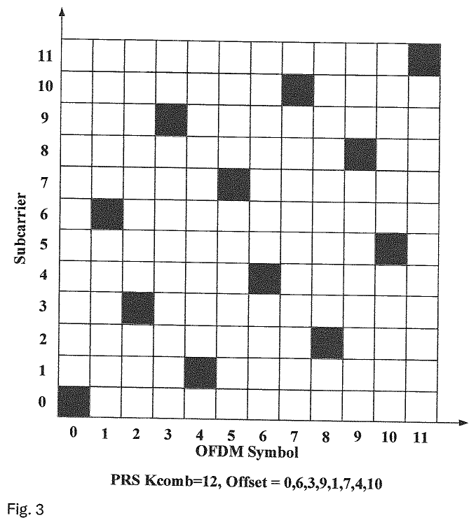

The 5G SRS is also allocated in 2D RBs, publicly known and vulnerable to AF relay jamming. Better SRS performance is also anticipated with the proposed 2D search algorithm against AF relay jamming by replacing the PRS with the SRS pattern. FIGS. 3 and 4 show examples of the 5G PRS pattern allocated in RBs.

AF TD FS relay jamming is most dangerous because it can pass through and damage any wireless communication system. In this invention, a low-complexity 2D 5G-and-beyond positioning algorithm was analytically derived for use against this serious AF TD FS relay jamming and expressed in 2D DFT or FFT. It is capable of accessing the proposed analytical 2D 5G-and-beyond positioning algorithm against AF TD FS relay jamming under practical channel environments in the future. Results of the 1D GPS positioning and 2D 5G PRS simulation confirmed the success of this proposed algorithm. For example, the probability of successfully detecting and removing an AF TD relay jamming signal becomes 1 when the AF TD relay jamming amplitude is higher than 1.1 under AWGN and E_{b}/N₀=10 dB. The critical AF TD relay jamming amplitude decreases when E_{b}/N₀ increases from-20 dB to 10 dB.

Also, the probability of successfully detecting and removing an AF TD relay jamming signal becomes 1 when the AF TD relay jamming power is higher than −55 dBm under AWGN and signal-to-noise ratio (SNR) larger than 15 dB.

The proposed algorithm can be applicable for synchronization also because the synchronization reference signal uses similar 2D OFDM resource blocks. The proposed algorithm can be useful for various civil and military positioning and synchronization devices against AF TD FS relay jamming.

For performing correlation between the received signal and a reference signal, a fast Fourier transform (FFT) can be used instead of integral or summation without sacrificing the performance of the invention. Either FFT or correlation will show equivalent performance and FFT will take faster signal processing.

The invented location signal enhancing process was tested under an additive white Gaussian noise (AWGN) channel and found to be effective for the existing 2D 5G PRS method, which is a 2D propagation time delay t and frequency shift search against AF relay jamming as well as the existing Global Positioning System (GPS) positioning, which is a 1D propagation time delay t search against AF relay jamming.

The 5G PRS is publicly known and vulnerable to AF relay jamming. Better PRS performance results were observed with the invented 2D location signal enhancing process for 5G-and-beyond positioning than the 1D GPS because the positioning resolution accuracy can be enhanced by 16 and 1,000 times due to the variable PRS bandwidth (BW) than 4G and L1 C/A GPS positioning, respectively.

Also, better PRS performance results were observed with the invented 2D location signal enhancing process for 5G-and-beyond positioning than the existing 2D 5G PRS method of no removal the AF relay jamming signal.

The 5G SRS is also allocated in 2D resource blocks (RBs), publicly known and vulnerable to AF relay jamming. Better SRS performance is also anticipated with the proposed 2D search algorithm against AF relay jamming by replacing the PRS with the SRS pattern.

FIGS. 3 and 4 show examples of the 5G PRS allocated in RBs.

The novelty of the invention is that the invented location signal enhancing process can effectively remove an AF relay jamming signal (whereas most existing anti-jamming schemes fail to suppress) and be applicable for protected positioning, navigation, and timing services with low complexity and cost.

FIG. 5 shows an example for a slot configuration for two 5G PRS resources. There are 14 OFDM symbols per subframe and ten subframes per frame. Therefore, the subframe interval is 933.38 μs≈1 ms, and the 5G frame interval is 9.3338 ms≈10 ms. This implies that there are seven OFDM symbols per slot and two slots per frame in 5G. The 5G PRS subcarrier size Fsc varies from 15 kHz to 30 kHz to 60 kHz to 120 kHz to 240 kHz. This implies that the 5G PRS bandwidth is flexible, and that the 5G PRS positioning resolution can be 16 times better than the 4G positioning resolution and 1,000 times better than the GPS L1 coarse acquisition (C/A) resolution. This is because the 5G subcarrier size can be 240 kHz while the 4G subcarrier size is fixed at 15 kHz, which is 16 times smaller, and the GPS chip time interval T_{c} is 1/chip rate, where the GPS L1 C/A chip rate R_{c}=1.023 Mcps. For example, the 5G positioning resolution can be 20 to 30 cm, the 4G resolution 3.2 to 4.8 m, and the GPS L1 C/A resolution cT_{c}=293.1 m, where c is the speed of light. For a general 5G PRS design guideline, the 5G OFDM sampling interval Tₛ is inversely proportional to the variable PRS BW, which is the number of resource blocks (NRB) times 12 subcarriers, i.e., BWPRS=12NRBF_{sc} because each RB consists of 12 subcarriers. If the subcarrier size is F_{sc}=240 kHz and the number of RBs is 347, then the 5G BWPRS becomes 1 GHz. In this case, the 5G OFDM sampling interval Tₛ will be 1 ns, and the positioning resolution will be cTₛ=0.3 m.

Preliminary results of the proposed positioning algorithm are presented, considering both one-dimensional search (i.e., only time delay) for L1 coarse acquisition (C/A) GPS signal and a 5G PRS two-dimensional search (i.e., time delay and frequency shift) under an AF TD relay jamming. For example, the period of the pseudo noise (PN) sequence is N=1,023 chips, as in the L1 C/A GPS signal. In the GPS, there are 20 PN sequence periods per bit, which means that 20N chips per bit=20,460 chips/bit. In this invention, only one PN sequence period per bit is assumed to demonstrate the proposed algorithm. The signal-to-noise is the bit energy-to-noise power spectral density ratio, i.e., E_{b}/N₀. The received signal at a GPS receiver was modeled as

$$r ( t ) = p ( t - 10 ) + p ( t - 40 ) + p ( t - 30 ) + {A}_{AF} p ( t - {τ}_{AF} ) + n ( t ) \qquad ( 4 )$$

where p(t−10), p(t−40), and p(t−30) are assumed from the three legitimate GPSs with waveform propagation time delays of 10T_{c}, 40T_{c}, and 30T_{c}, respectively; the chip time interval T_{c} is normalized to 1 second for simulation; the AF relay jamming signal is an amplified and time-shifted version of the same m-sequence p(t) with amplifier gain A_{AF}=10 and time-shift τ_{AF}=50; and n (t) is the AWGN at the GPS receiver with mean zero and power equal to the inverse of SNR. FIG. 5 shows an example of the discrete time received signal r[n].

The cyclic cross-correlation R[m] between the GPS receiver signal r[n]=r(t=nT_{c}) in (4) and the PN sequence p[n]=p(t=nT_{c}) versus the lag m is taken under the AF TD relay jamming signal of A_{AF}=10 and τ_{AF}=50, and SNR=10 dB. The R[m] can be written as

$$R [ m ] = 〈 r [ n ] , p [ n ] 〉 ( m ) = {\sum }_{n = 0}^{N - 1} r [ n ] p [ n + m ] \qquad ( 5 )$$

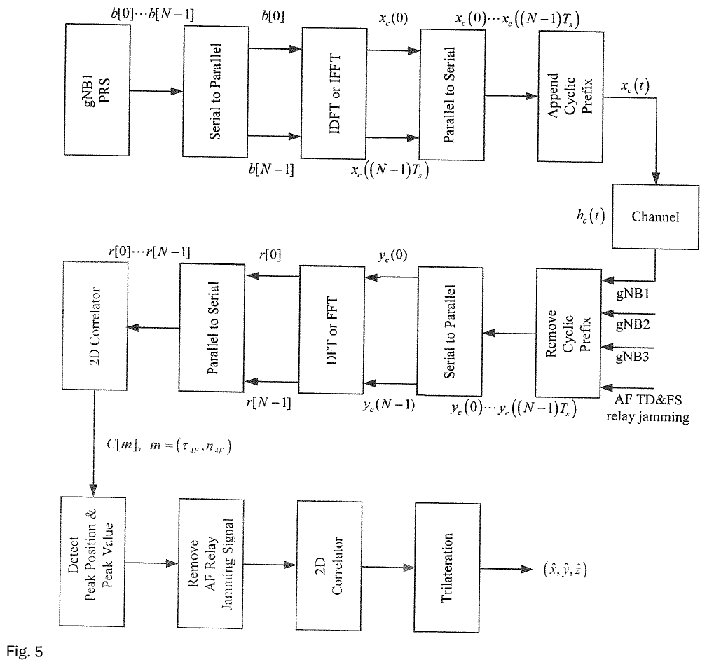

Three peaks around value 1,023 and a large peak around value 10,230 in the cross-correlation can be observed in FIG. 6, as expected. The largest peak is due to the AF TD relay jamming, and its peak position is at 50, which is the TD introduced by the jammer.

The TD can be estimated as the cross-correlation peak position mₚₑₐₖ. Hence, the AF TD relay jamming signal can be estimated as

$${\hat{A}}_{AF} p ( t - {\hat{τ}}_{D} ) = \sqrt{\frac{R [ {m}_{peak} ]}{N}} p ( t - {m}_{peak} {T}_{c} ) \qquad ( 6 )$$

and subtracted from the received signal as

$$\hat{r} ( t ) = r ( t ) - {\hat{A}}_{AF} p ( t - {m}_{peak} {T}_{c} ) . \qquad ( 7 )$$

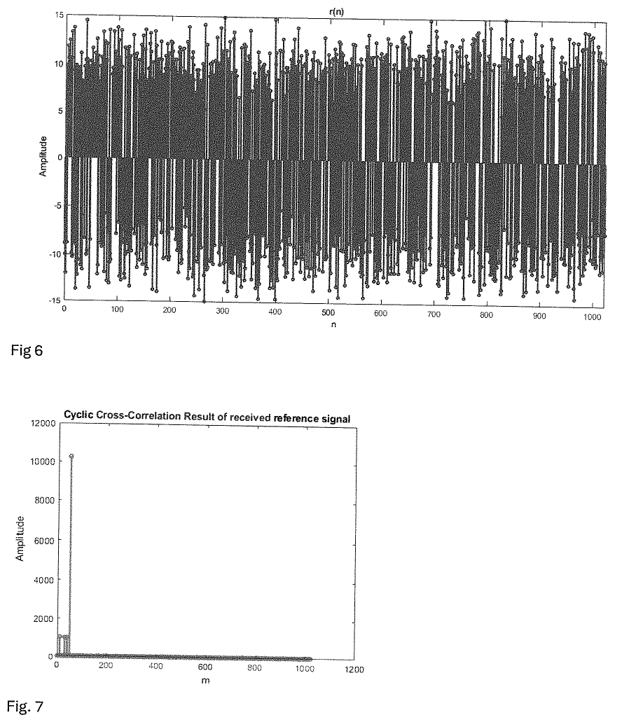

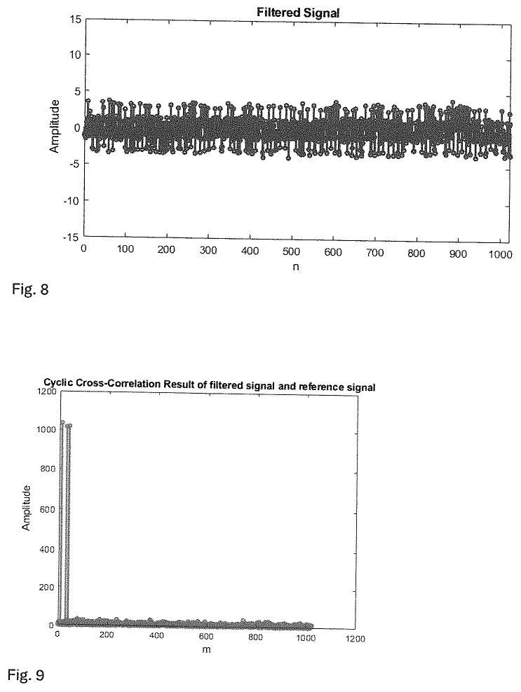

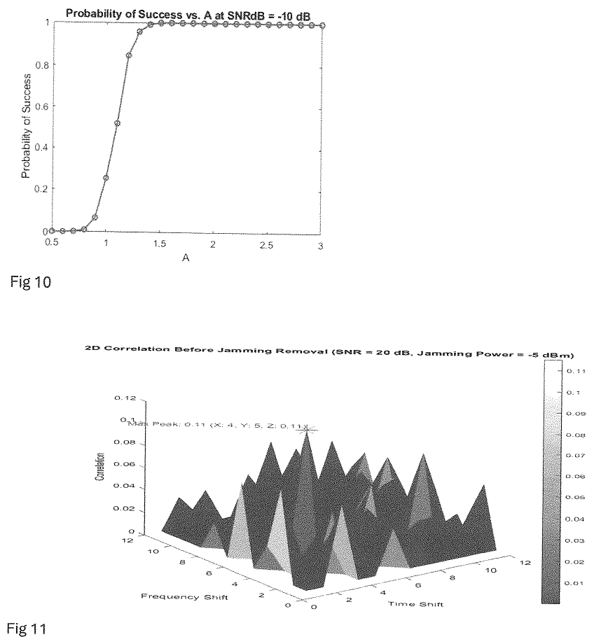

Then, the discrete-time signal r\hat{ }[n] is fed to Step 4 of the proposed algorithm. FIGS. 7 and 8 show examples for the received signal after elimination of AF TD jamming signal in (7) and the cyclic cross-correlation between the reference PN signal p[n] and filtered signal r\hat{ }[n], respectively. All these operations in Steps 1 through 4, i.e., (5) through (7), can be performed with FFT.

FIG. 9 shows the probability of success versus A_{AF}=A for SNR=−10 dB. For each jamming signal amplitude A_{AF}, 500 trials were made. Here, the probability of success means that the GPS receiver successfully detects the presence of the AF TD relay jamming signal, removes it from the received signal, and correctly finds the propagation time delays of the three legitimate GPS signals. The following observations can be made: The probability of successfully detecting the AF TD relay jamming signal becomes 1 when the jamming amplitude A_{AF}≥2.3, ≥1.5, ≥1.2, and ≥1.1, and the E_{b}/N₀=−20 dB, −10 dB, 0 dB, and 10 dB, respectively. In other words, the critical AF TD relay jamming amplitude, beyond which the probability of successfully detecting becomes 1, decreases as the SNR increases. The jammer should decrease its amplitude to be effective against the proposed algorithm.

However, when the jamming signal amplitude A_{AF}<1, the probability of successfully finding the GPS receiver position increases. A game theoretical analysis can be involved in finding the equilibrium of the AF relay jamming amplitude.

The probability of successfully detecting the AF TD relay jamming signal presence is analytically derived under an AWGN channel and an AF TD relay jamming signal when three legitimate GPS received signals have equal power. The probability of success can be written for an AF relay jamming signal amplitude as

$$Pr [ Success \vert {A}_{AF} = A ] = \qquad ( 8 )$$

$${[ {\int }_{- ∞}^{∞} Q ( ( x - NA ) / σ ) \cdot 1 / \sqrt{2 {πσ}^{2}} \cdot exp ( - {( x - N )}^{2} / ( 2 {σ}^{2} ) ) dx ]}^{3}$$

$$where Q ( α ) = {\int }_{α}^{∞} {e}^{- {t}^{2} / 2} / \sqrt{2 π} dt .$$

The analysis in (8) can be extended for the case when three legitimate GPS received signals have different power levels. It was observed that the estimated positioning outputs were close to those of the ideal case, i.e., no jamming and no thermal noise when the estimated AF TD jamming signal was removed, whereas the estimated positioning outputs when AF TD relay jamming was present were much different from the true ones.

The proposed algorithm can be applicable for various systems, for examples, 5G-and-beyond positioning, 5G and-beyond synchronization, 5G-and-beyond autonomous driving vehicles, autonomous guided vehicles in factory, drones, automatic PNT services, emergency services, etc.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. An apparatus comprising:
a receiver system that receives, via a plurality of signal transmitter systems, multiple signals comprising a range of frequencies that carry information;
a plurality of transmitter system that transmit, a number of frequencies for the receiver system to process the information; and
an anti-jamming system comprising:
a jamming signal detection system located within at least one transmitter system utilizing an algorithm comprising;
removing or preventing a jamming signal from being received by a transmitter system wherein the algorithm is a series of steps comprising:
taking a first measurement of the 2D cyclic-cross correlation between a discrete-time received signal vector and a known 5G PRS;
detecting the presence of an AF, TD and FS jamming signal;
estimating the strength of the AF, TD, and FS relay jamming signal using the peak value and the peak position lag;
filtering out any AF relay jamming signal that is detected; and
taking a second measurement of the 2D cyclic-cross correlation between the known PRS vector b and the received signal vector to determine if the AF jamming signal is eliminated;
a control system, and a network, that within a coverage area of the receiver system via can determine the location of the transmitter system relative to the receiving system allowing reception of all signals at the receiver system and preventing jamming signals from interfering with the signals from the transmitting systems based on the position of the receiver system and transmitter systems.

2. The apparatus of claim 1 wherein the information sent by the transmitting systems can contain location information, directional information, system operation information and other information needed or used by the transmitting systems.

3. An anti-jamming apparatus comprising:
processing circuitry arranged to:
train each of receiving system and transmitting system using algorithms to determine the presence of a jamming signal and prevent the interruption of signals sent to the receiving system or from the transmitting system;
classify a detected signal on a sensing channel using an algorithm to track the jamming signal, notify users of a potential jamming signal, adjust receiving systems and transmitting systems to alter operations to continue operation in the presence of a jamming signal;
after initial training of each of the receiving and transmitting system:
the algorithm configures the receiving system to determine whether the jamming signal is present on a current receiving channel and the algorithm configures the transmitting system to communicate using an communications channel which is not jammed.

4. A signal anti-jamming method comprising:
Applying an algorithm to remove or prevent a jamming signal from being received by a receiving system wherein the algorithm is a series of steps comprising:
taking a first measurement of the 2D cyclic-cross correlation between a discrete-time received signal vector and a known 5G PRS;
detecting the presents of an AF, TD, and FS jamming signal;
estimating the strength of the AF, TD, and FS relay jamming signal using the peak value and the peak position lag;
filtering out any AF relay jamming signal that is detected; and
taking a second measurement of the 2D cyclic-cross correlation between the known PRS vector b and the received signal vector to determine if the AF jamming signal is eliminated.

5. The signal anti-jamming method of claim 4 wherein a known 5G PRS vector is assigned in both the orthogonal frequency division multiplexing (OFDM) subcarrier frequency and the OFDM symbol time domain.

6. The signal anti-jamming method claim 4 wherein the presence of an AF TD and FS relay jamming signal is detected by observing if the 2D cyclic-cross correlation peak value is larger than a predetermined normal operation threshold.

7. The signal anti-jamming method f claim 4 wherein the algorithm may be repeated for every node or transmitting system.

8. The signal anti-jamming method of claim 3 wherein a trilateral algorithm is applied to estimate the position of one or more transmitting systems within the range of a receiving system.
